(19) United States
(12) Patent Application Publication
(10) Pub. No.: US 2004/0128835 A1
(43) Pub. Date: Jul. 8, 2004

(54) Bidirectional shaving cartridge and razor including same

(75) Inventors: David C. Coffin, Hamden, CT (US); Randy Nicolosi, Shelton, CT (US); Andrew J. Pennella, Stamford, CT (US)

Correspondence Address: Richard R. Michaud, McCormick, Paulding & Huber LLP, CityPlace II, 185 Asylum Street, Hartford, CT, 06103, US

(73) Assignee: Eveready Battery Company, Inc., Westlake, OH

(21) Appl. No.: 10/686,992

(22) Filed: Oct. 16, 2003

Related U.S. Application Data
(60) Provisional application No. 60/420,273, filed on Oct. 21, 2002.

(51) Int. Cl. B26B 21/14; B26B 21/52

(52) U.S. Cl. 30/50; 30/57; 30/528; 30/77; 30/527

(57) ABSTRACT

A blade cartridge for a wet shaving device comprises a housing including a lower housing member and an upper housing member cooperating to define a cavity. First and second blade assemblies are disposed within the cavity. Each of the first and second blade assemblies includes at least one blade defining a cutting edge, wherein the cutting edge of the blade of the first blade assembly generally faces the cutting edge of the blade of the second blade assembly to permit bidirectional shaving.

### CROSS-REFERENCE TO RELATED APPLICATIONS

This application is entitled to the benefit of and incorporates by reference essential subject matter disclosed in Provisional Patent Application No. 60/420,273 filed on Oct. 21, 2002.

### FIELD OF THE INVENTION

This invention relates generally to razor blade devices, and more particularly to a bidirectional wet shaving device.

### BACKGROUND OF THE INVENTION

Typical wet shaving devices comprise single or multiple blades aligned in one direction such that the shaving devices are unidirectional (i.e., razor is configured such that the blades can only cut along one direction). A drawback with unidirectional shaving devices is that the razor must be lifted off of a hirsute surface during a return stroke in order to properly position the razor for a subsequent cutting stroke. The return stroke increases the time required for shaving large hirsute surfaces such as, for example, the legs of a user. A second drawback is that the scraping of the skin during the initialization of each cutting stroke can tend to cause discomfort.

In response to the foregoing, it is an object of the present invention to improve upon or overcome the drawbacks and disadvantages of prior art unidirectional wet shaving devices.

### SUMMARY OF THE INVENTION

In a first aspect of the present invention, a blade cartridge for a wet shaving device comprises a housing including a lower housing member and an upper housing member cooperating to define a cavity. First and second blade assemblies are disposed within the cavity. Each of the first and second blade assemblies includes at least one blade defining a cutting edge. The cuffing edge of the at least one blade of the first blade assembly generally faces the cutting edge of the at least one blade of the second blade assembly to permit bidirectional shaving.

Preferably, each blade cartridge includes a plurality of blades, and more preferably two blades, to provide a “closer” shave than otherwise possible with a single blade. Moreover, each of the blade assemblies is preferably movable into the housing in response to excessive forces exerted on the associated blades in order to minimize injury to the user. A resilient member, such as a spring wire, is preferably interposed between at least one of the blade assemblies and the housing for permitting the movement of the blade assemblies into the housing and for providing a restoring force to the blade assemblies. As a further safety measure, a wire may be helically wound along the cutting edges of the blades in order to prevent the skin from extruding between the blades.

The housing of the blade cartridge may define a plurality of first channels as part of the cavity extending between side ends of the blade cartridge, and a plurality of second channels as part of the cavity extending between longitudinal ends of the blade cartridge in a direction generally perpendicular to that of the first drain channels to facilitate flushing of debris that has settled within the cavity.

In a second aspect of the present invention, a wet shaving razor comprises a handle, and a housing coupled to the handle. The housing includes a lower housing member and an upper housing member cooperating to define a cavity. First and second blade assemblies are disposed within the cavity. Each of the first and second blade assemblies includes at least one blade defining a cutting edge, wherein the cutting edge of the at least one blade of the first blade assembly generally faces the cutting edge of the at least one blade of the second blade assembly to permit bidirectional shaving.

Preferably, the handle of the wet shaving razor includes a coupling means having supports for engaging end walls of the housing such that the orientation of the handle with respect to the blades permits a bidirectional shaving operation to be performed by a combing motion. Preferably the supports are pivotally coupled to the housing so that the razor may easily pivot along the surface being shaved.

### BRIEF DESCRIPTION OF THE DRAWINGS

FIG. 1 is a top perspective view of a blade cartridge including two blade subassemblies in opposing relationship with one another in accordance with the present invention.

FIG. 2 is a side elevational view of the blade cartridge of FIG. 1.

FIG. 3 is an end elevational view of the blade cartridge of FIG. 1.

FIG. 4 is a top perspective view of a blade subassembly.

FIG. 5 is a bottom perspective view of a blade subassembly.

FIG. 6 is a cross-sectional view of the blade cartridge of FIG. 1 taken along the line 6-6 in FIG. 1.

FIG. 7 is a side view of a razor handle for the blade cartridge of FIG. 1.

### DETAILED DESCRIPTION OF THE PREFERRED EMBODIMENT

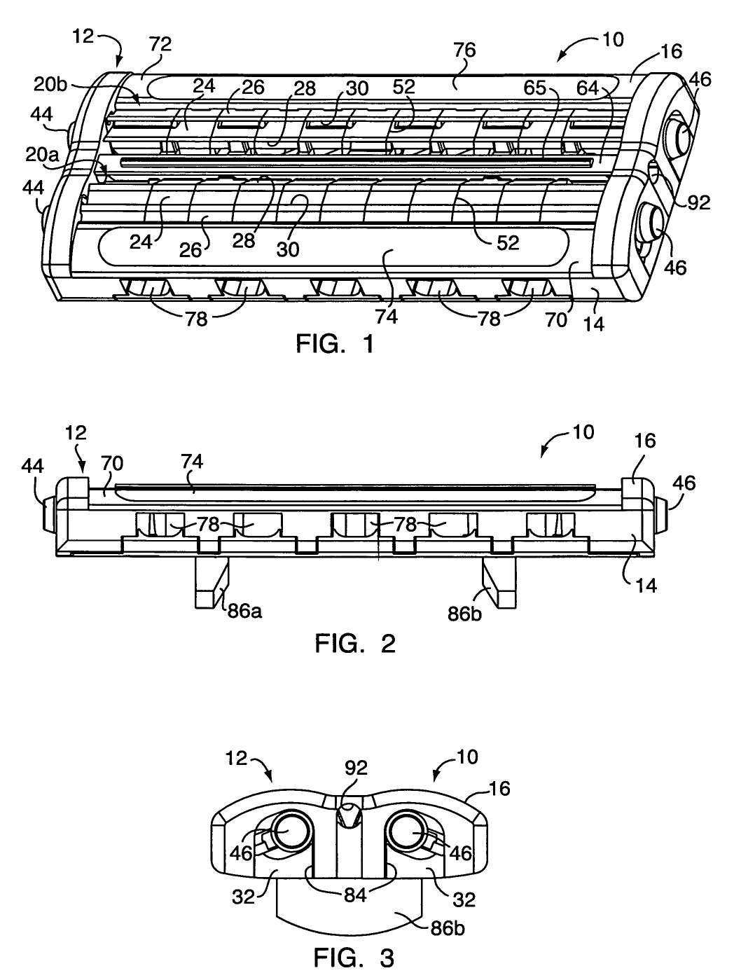

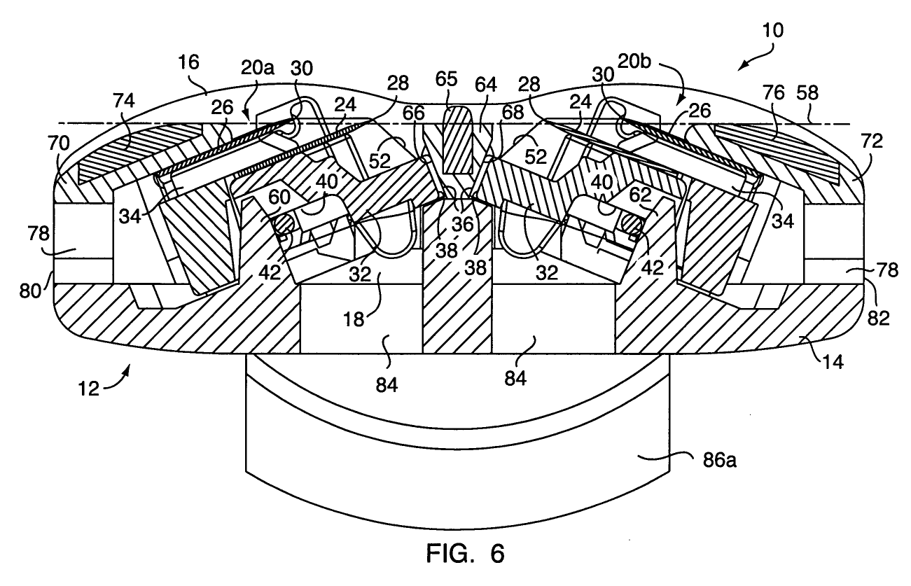

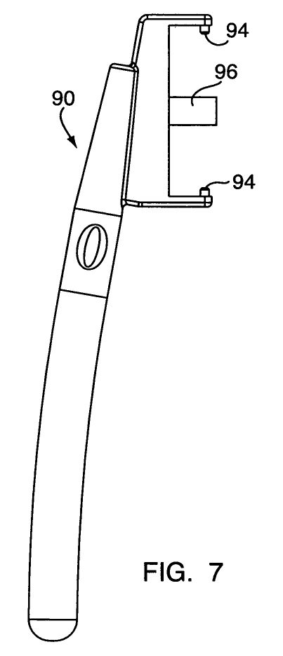

With reference to FIGS. 1 and 2, a blade cartridge embodying the present invention is indicated generally by the reference number 10. The blade cartridge 10 comprises a housing 12 preferably including a lower housing member 14 and an upper housing member 16 cooperating to define a cavity 18 (see FIG. 6). As best shown in FIG. 1, the upper housing member 16 is generally rectangular, but may be other shapes, such as oval or round, without departing from the scope of the present invention. A first blade assembly 20a and a second blade assembly 20b are disposed within the cavity 18. The first and second blade assemblies 20a, 20b are generally the same shape, and preferably are identical to each other. Although each blade assembly is shown as having two blades, it should be understood that the blade assemblies 20a, 20b can have any practical number of blades such as, for example, one, two, three, four or five blades, without departing from the scope of the present invention.

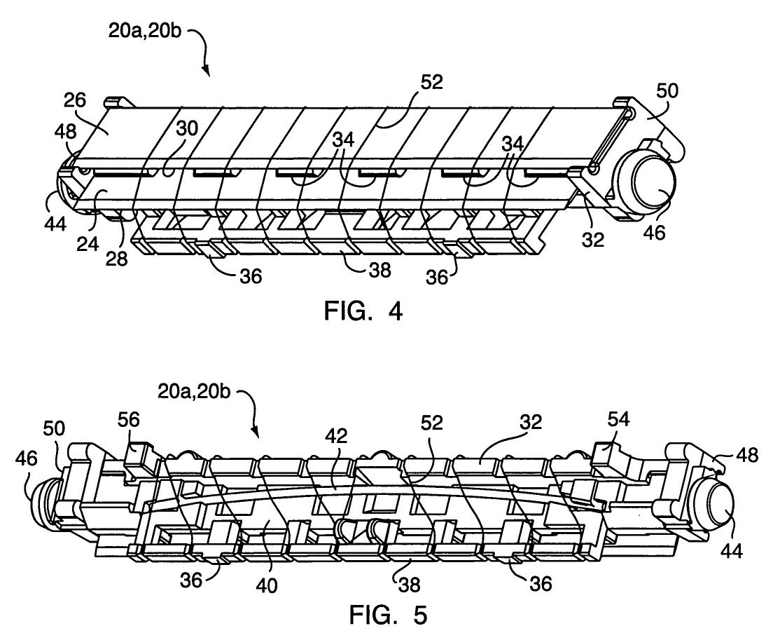

As best shown in FIGS. 4 and 5, each of the blade assemblies 20a and 20b includes a first blade 24 and a second blade 26 having respective cutting edges 28 and 30 that are generally parallel to each other. The blades 24, 26 are mounted on a carrier 32 and are separated from one another by one or a plurality of spacers 34, 34 interposed between and spaced along the length of the blades 24, 26. As shown in FIG. 4, the first blade 24 is located underneath and slightly forwardly of the second blade 26, whereby the first blade precedes the second blade along a shaving stroke. Each of the blade assemblies 20a, 20b preferably further includes front abutment surfaces 36, 36 projecting outwardly from a front, lower edge 38 of the associated blade assembly to limit movement of the blade assembly within the blade cartridge 10 as will be explained more fully below.

As shown in FIG. 5, the carrier 32 of each of the blade assemblies 20a, 20b has a bottom surface 40 upon which a resilient member 42 is mounted. Preferably, the resilient member 42 is an elongated strip of flexible material such as, for example, plastic or metal, that is mounted on the bottom surface 40 such that the resilient member is bowed or flexed generally rearwardly from the bottom surface 40. The resilient member 42 is a safety feature which flexes and thereby permits an associated blade assembly to move generally rearwardly into the housing 12 independently of the other blade assembly when an excessive shaving force is exerted on the blades 24 and 26, and provides a restoring force to the associated blade assembly to return the blade assembly to its proper position in relation to the housing 12 when the excessive shaving force is removed from the blades. The blade cartridge 10 may be configured such that each side has similar or dissimilar shaving geometry or restoring force characteristics such that it may provide a different degree of shaving efficiency for the up and down stroke.

The carrier 32 of each of the blade assemblies 20a and 20b may further include first and second projections 44, 46 extending outwardly from respective first and second longitudinal ends 48, 50 thereof. The projections 44, 46 allow the user to push downwardly thereon in order to test the safety feature of downward movement of the blade assemblies 20a, 20b within the housing 12 of the blade cartridge 10.

Preferably, a wire 52 is helically wound along the cutting edges 28, 30 of each of the blade assemblies 20a, 20b generally from the first longitudinal end 48 to the second longitudinal end 50. The wire 52 provides an additional safety feature for preventing skin from extruding between the blades, and the user from cuffing or otherwise damaging the portion of the skin engaging the blades. The bottom surface 40 of the carrier 32 for each of the blade assemblies 20a and 20b includes first and second posts 54 and 56 respectively located adjacent to the first and second longitudinal ends 48 and 50 for securing thereto ends of the wire 52.

As best shown in FIGS. 4 and 5, the first and second blade assemblies 20a, 20b are mounted within the cavity 18 defined by the housing 12 of the blade cartridge 10 such that the cuffing edges 28, 30 of the first blade assembly 20a generally face cutting edges 28, 30 of the second blade assembly 20b to thereby permit bidirectional shaving (i.e., shaving in both forward and return stroke directions).

As best shown in FIG. 6, planar surfaces of the first and second blade assemblies 20a, 20b are slightly inclined with respect to a shaving plane 58 or plane of contact with the skin of a user. The cutting edges 28, 30 of the blades in an undepressed position extend slightly beyond the shaving plane 58 just enough distance to expose the edges in order to cut hair from the user's skin without cutting or otherwise damaging the skin. The lower housing member 14 defines first and second rearward stop surfaces or fin members 60, 62 upon which the resilient members 42 of respective first and second blade assemblies 20a, 20b bear against. As the blade assemblies 20a and 20b are moved inwardly into the housing 12 under excessive shaving forces, the resilient members 42 deform when pressed against the stop surfaces 60 and 62 and thereby build-up a restoring force within the resilient members which returns the blade assemblies to the undepressed position with respect to the shaving plane 58 when the excessive shaving forces are removed. The upper housing member 16 includes an upper centrally located guard or stop member 64 having first and second forward stop surfaces 66, 68 for respectively engaging the front abutment surfaces 36, 36 of the first and second blade assemblies 20a, 20b to properly locate the cutting edges 28, 30 of the blades in the undepressed position with respect to the shaving plane 58. The guard 64 may also include an elastomeric member 65 projecting upwardly therefrom into the shaving plane 58 to aid skin stretching and improve shaving closeness.

As shown in FIG. 6, the upper housing member 16 may include first and second caps 70 and 72 for generally covering first and second blade assemblies 20a and 20b, respectively. The upper housing member 16 may also include first and second shaving aids 74 and 76 positioned generally above the first and second caps 70 and 72, respectively, for applying a shaving lubricant such as a gel to the skin surface being shaved.

As shown in FIGS. 1, 2 and 6, preferably the lower housing member 14 and the upper housing member 16 cooperate to define a plurality of first drain channels 78, 78 as part of the cavity 18. The first drain channels 78, 78 extend between a first side end 80 and a second side end 82 of the blade cartridge 10 in order to facilitate the flushing of debris that has settled within the cavity 18. As best shown in FIGS. 3 and 6, the lower housing member 14 preferably defines a plurality of second drain channels 84, 84 extending generally in a direction perpendicular to that of the first drain channels 78, 78 between the first longitudinal end 48 and the second longitudinal end 50 of the blade cartridge 10 to further facilitate the flushing of debris from the cavity 18.

Referring to FIGS. 2, 3 and 6, the lower housing member 14 may include first and second arcuate track members 86a, 86b that engage surfaces on a razor handle 90 (see FIG. 7) to provide pivotal movement of the blade cartridge 10 relative to the handle. The advantage of this method of pivoting is that the actual center of pivoting may be preferably positioned on or dose to the shaving plane 58. For example, the center of pivoting may be within a range from substantially on the shaving plane 58 to about 1.0 mm below the shaving plane. Alternatively, the lower housing member 14 and the upper housing member 16 may define cylindrical holes 92, 92 in each end wall for engaging axles or coaxial pins 94, 94 provided on the razor handle 90 to allow pivotal movement of the blade cartridge 10 relative to the handle. The blade cartridge 10 thus attaches to the handle 90 at its ends such that the blades 24, 26 of the blade cartridge extend in a direction generally parallel to that of the length of the handle. This enables the user to use a “combing” motion allowing improved visibility for both front and back strokes as opposed to prior bidirectional razor handles that attach to cartridges such that the blades extend in a direction generally perpendicular to that of the length of the handle. For bidirectional movement such prior configurations result in a push/pull movement—much like a lawn mower or carpet sweeper. In the push direction the handle, cartridge and user's hand obscure visibility.

With reference to FIG. 7, a leaf spring member 96 extends outwardly from and in a direction generally perpendicular to that of the length of the handle 90 to engage with an opening defined in a side wall of the lower housing member 14 of the blade cartridge 10 to provide a restoring moment to return the blade cartridge to a neutral position after pivoting.

As will be recognized by those of ordinary skill in the pertinent art, numerous modifications and substitutions may be made to the above-described embodiment of the present invention without departing from the scope of the invention as set forth in the appended claims. Accordingly, the preceding portion of this specification is to be taken in an illustrative, as opposed to a limiting sense.

What is claimed is:

1. A blade cartridge for a wet shaving device, the blade cartridge comprising:
a housing including a lower housing member and an upper housing member cooperating to define a cavity; and
first and second blade assemblies disposed within the cavity, each of the first and second blade assemblies including at least one blade defining a cutting edge, and wherein the cutting edge of the at least one blade of the first blade assembly generally faces the cutting edge of the at least one blade of the second blade assembly to permit bidirectional shaving.

2. A blade cartridge as defined in claim 1, wherein the first and second blade assemblies are generally the same shape.

3. A blade cartridge as defined in claim 1, wherein the blades of the first and second blade assemblies are inclined relative to each other.

4. A blade cartridge as defined in claim 1, wherein the first and second blade assemblies each include two blades.

5. A blade cartridge as defined in claim 1, wherein at least one of the first and second blade assemblies is movable into the housing in response to an excessive force being exerted on the at least one blade of the associated blade assembly.

6. A blade cartridge as defined in claim 1, wherein each of the first and second blade assemblies is movable into the housing in response to an excessive force being exerted on the at least one blade of the associated blade assembly.

7. A blade cartridge as defined in claim 5, further including at least one resilient member interposed between the at least one of the first and second blade assemblies and the housing for permitting the movement of the at least one of the first and second blade assemblies into the housing.

8. A blade cartridge as defined in claim 7, wherein the at least one resilient member is interposed between the at least one of the first and second blade assemblies and the lower housing member.

9. A blade cartridge as defined in claim 7, wherein the at least one resilient member is a spring wire having a shape bowed rearwardly of the at least one of the first and second blade assemblies for providing a restoring force to the associated blade assembly.

10. A blade cartridge as defined in claim 1, further including a wire wound along cutting edges of the blades for preventing skin from extruding between the blades.

11. A blade cartridge as defined in claim 1, wherein the housing defines a plurality of channels as part of the cavity extending between side ends of the blade cartridge to facilitate flushing of debris that has settled within the cavity.

12. A blade cartridge as defined in claim 1, wherein the housing defines a plurality of channels as part of the cavity extending between longitudinal ends of the blade cartridge to facilitate flushing of debris that has settled within the cavity.

13. A blade cartridge as defined in claim 1, wherein the housing defines a plurality of first channels as part of the cavity extending between side ends of the blade cartridge, and a plurality of second channels as part of the cavity extending between longitudinal ends of the blade cartridge, the second channels extending in a direction generally perpendicular to that of the first drain channels, the first and second drain channels serving to facilitate flushing of debris that has settled within the cavity.

14. A blade cartridge as defined in claim 1, further comprising at least one arcuate track member coupled to the lower housing member for pivotal engagement with a handle.

15. A blade cartridge as defined in claim 14, wherein the at least one arcuate track member is configured to provide a center of pivoting located on or dose to a shaving plane.

16. A blade cartridge as defined in claim 14, wherein the at least one arcuate track member includes first and second track members located generally at opposite sides of the housing relative to each other.

17. A wet shaving razor comprising:
a handle;
a housing coupled to the handle, the housing including a lower housing member and an upper housing member cooperating to define a cavity; and
first and second blade assemblies disposed within the cavity, each of the first and second blade assemblies including at least one blade defining a cutting edge, and wherein the cutting edge of the at least one blade of the first blade assembly generally faces the cutting edge of the at least one blade of the second blade assembly to permit bidirectional shaving.

18. A wet shaving razor as defined in claim 17, further including means associated with the handle for releasably coupling the housing to the handle.

19. A wet shaving razor as defined in claim 18, wherein the coupling means includes first and second elongated supports spaced from one another and each projecting outwardly from the handle in a direction generally parallel with each other and generally perpendicularly to a length of the handle, the first and second supports for engaging with end walls of the housing, whereby the orientation of the handle with respect to the blades permits a bidirectional shaving operation to be performed by a combing motion.

20. A wet shaving razor as defined in claim 19, wherein the end walls of the housing and the first and second elongated supports include pivot means for pivotally coupling the housing to the handle.

21. A wet shaving razor as defined in claim 20, wherein the pivoting means includes holes defined by one of the elongated supports of the handle and the end walls of the housing, and projections defined by the other of the elongated supports and the end walls for pivotally mating with the holes.

22. A wet shaving razor as defined in daim 20, wherein the pivoting means includes holes defined by the end walls of the housing, and projections defined by the elongated supports of the handle for pivotally mating with the holes.

23. A wet shaving razor as defined in claim 19, wherein a side wall of the housing defines an opening, and the coupling means further includes a leaf spring interposed between and projecting in a direction generally parallel with the first and second elongated supports, the leaf spring for being received in the opening of the housing for providing a restoring force to pivoting action of the housing with respect to the handle.

24. A wet shaving razor as defined in claim 17, further comprising at least one arcuate track member pivotally coupling the housing to the handle.

25. A wet shaving razor as defined in claim 24, wherein the at least one arcuate track member is configured to provide a center of pivoting on or dose to a shaving plane.

26. A wet shaving razor as defined in claim 24, wherein the at least one arcuate track member includes first and second track members located generally at opposite sides of the housing relative to each other.
